(19) United States
(12) Patent Application Publication
(10) Pub. No.: US 2019/0205044 A1
(43) Pub. Date: Jul. 4, 2019

(54) DEVICE FOR RESTORING LOST DATA DUE TO FAILURE OF STORAGE DRIVE

(71) Applicant: HITACHI, LTD., Tokyo (JP)

(72) Inventors: Tomohiro KAWAGUCHI, Tokyo (JP); Ai SATOYAMA, Tokyo (JP); Kazuei HIRONAKA, Tokyo (JP); Akira DEGUCHI, Tokyo (JP)

(73) Assignee: HITACHI, LTD., Tokyo (JP)

(21) Appl. No.: 16/332,079

(22) PCT Filed: Jan. 10, 2017
(86) PCT No.: PCT/JP2017/000445

§ 371 Date: Mar. 11, 2019

(51) Int. Cl. G06F 3/06

(52) U.S. Cl. CPC G06F 3/0619; G06F 3/064; G06F 3/0689

(57) ABSTRACT

A method for restoring lost data due to a failure of a storage drive is provided, including: selecting a first logical area of a first storage drive that is failed; specifying a first logical area line that includes the first logical area and logical area blocks of a different storage drive and stores a data set having a redundant configuration capable of restoring lost internal data; selecting, from the first logical area line, one or more second logical areas to be accessed for restoring data of the first logical area; and for each of one or more second storage drives that provides the one or more second logical areas respectively, issuing a data storage information request inquiring whether valid data is stored after designating the second logical areas.

### TECHNICAL FIELD

The present invention relates to a device for restoring lost data due to a failure of a storage drive.

### BACKGROUND ART

There has been a continuous demand for reducing the bit cost for a storage drive in order to reduce the device cost. In order to meet the demand, it is expected to increase data concentration degree per storage drive, that is, to increase the capacity per storage drive. Accordingly, the rebuilding time is lengthened when a storage drive fails. The rebuilding is to generate data of the failed drive based on other normal drives constituting a Redundant Arrays of Inexpensive Disks (RAID) and store the data in a spare drive, so as to reconstitute a normal RAID configuration.

For example, JP-A-2009-116783 discloses a technique for shortening the time during which a state of low reliability continues due to a failure of a physical storage device. More specifically, JP-A-2009-116783 discloses the following matters.

“With respect to a virtual volume whose capacity is dynamically enlarged, mapping information indicating which physical area is allocated to which virtual area is stored. In addition, physical area management information indicating which physical area is allocated to which virtual area is stored. Whether a low-reliability physical area, in which reliability has decreased due to a failure in a certain physical storage device, belonging to an RAID group including the physical storage device is allocated to a virtual area is determined by referring to the physical area management information. For the low-reliability physical area that is not allocated to the virtual area, the data restoration process is not performed, and for the low-reliability physical area that is allocated, the data restoration process is performed.” (Abstract)

### PRIOR ART LITERATURE

### Patent Literature

PTL 1: JP-A-2009-116783

### SUMMARY OF INVENTION

### Technical Problem

For example, in the above-described related art, lost data is restored for each page that is a unit for allocating a physical page to a virtual volume. In the above-described related art, on a premise that the valid data is stored in the whole area in a page, all data including 0 data in the page is read to restore the lost data.

However, in the page, there may be an area where the valid data is not stored. When the valid data is not stored in the area, that is, 0 data is stored, the data of the area does not affect the result of an exclusive OR operation when the lost data is restored. Due to the unnecessary arithmetic process of 0 data, restoration time and rebuilding time of the lost data is increased. Therefore, a technique capable of restoring the lost data more efficiently is desired.

### Solution to Problem

A representative example of the present disclosure relates to a device for restoring lost data due to a failure of a storage drive, the device including a memory and a processor that operates according to a program stored in the memory, wherein the processor selects a first logical area of a first storage drive that is failed; specifies a first logical area line that includes the first logical area and logical area blocks of a different storage drive and stores a data set having a redundant configuration capable of restoring lost internal data; selects, from the first logical area line, one or more second logical areas to be accessed for restoring data of the first logical area; for each of one or more second storage drives that provides the one or more second logical areas respectively, issues a data storage information request inquiring whether valid data is stored after designating the second logical areas, issues a read request designating the second logical areas when a response for the data storage information request is returned which indicates that the valid data is stored, omits the read request when the response for the data storage information request is returned which indicates that the valid data is not stored; and restores the data of the first logical area by using data read from the one or more second storage drives.

### Advantageous Effect

According to the example of the invention, lost data can be restored efficiently.

### BRIEF DESCRIPTION OF DRAWINGS

FIG. 1 illustrates an outline of an embodiment.

FIG. 2 illustrates a configuration of a computer system according to Embodiment 1.

FIG. 3A illustrates a relation among a logical volume (virtual volume), a virtual page, a physical page and an RAID group.

FIG. 3B illustrates exemplary configurations of logical segments and physical segments of a storage drive according to Embodiment 1.

FIG. 4 illustrates an exemplary configuration of drive configuration management information according to Embodiment 1.

FIG. 5A illustrates a flowchart of a process in response to a read request from a host computer according to Embodiment 1.

FIG. 5B illustrates a detailed flowchart of staging in FIG. 5A according to Embodiment 1.

FIG. 6 illustrates a flowchart of a process in response to a write request from the host computer according to Embodiment 1.

FIG. 7 illustrates a flowchart of a process in response to an area release request from the host computer according to Embodiment 1.

FIG. 8 illustrates a flowchart of a rebuilding process in response to a failure of a storage drive according to Embodiment 1.

FIG. 9 illustrates an exemplary configuration of page allocation management information according to Embodiment 2.

FIG. 10 illustrates a flowchart of a rebuilding process according to Embodiment 2.

FIG. 11 illustrates a volume configuration according to Embodiment 3.

FIG. 12 illustrates a configuration of a computer system according to Embodiment 3.

FIG. 13 illustrates a flowchart of a forming copying process in response to a storage control program failure according to Embodiment 3.

FIG. 14 illustrates an exemplary configuration of a remote copy pair according to Embodiment 3.

### DESCRIPTION OF EMBODIMENTS

Hereinafter, some embodiments of the invention will be described with reference to the drawings. It should be noted that these embodiments are only examples for carrying out the invention and the technical scope of the invention is not limited thereto.

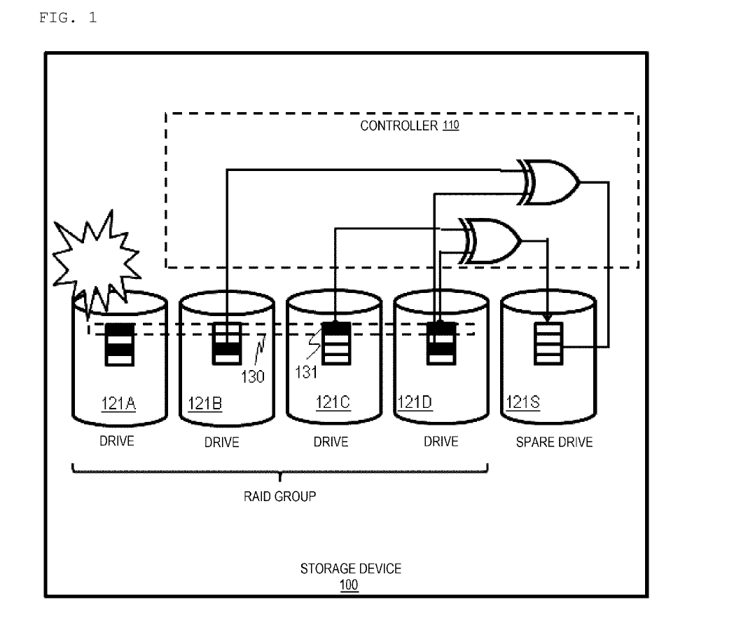

Hereinafter, restoration of lost data due to a storage drive (also referred to as storage device or drive) failure is disclosed. FIG. 1 illustrates an outline of an embodiment. A storage device 100 includes a controller 110, and storage drives 121A to 121D, and 121S. The storage drives 121A to 121D constitute a Redundant Arrays of Inexpensive Disks (RAID) group. The storage drive 121S is a spare drive. The storage drives 121A to 121D, and 121S are, for example, flash drives including a flash memory.

A logical address space of each of the storage drives 121A to 121D that constitute the RAID group is divided into a plurality of storage areas 131 having a fixed size (for example, 256 KB) which are called stripe blocks for management. The stripe blocks 131 are data stripe blocks storing host data written from a host computer or 0 data, or are parity stripe blocks storing redundant data or 0 data.

The parity stripe blocks and data stripe blocks for generating the redundant data stored in the parity stripe blocks constitute a stripe line 130. The stripe line is a logical area line, and a data set stored in the stripe line has a redundant configuration and, when a portion of internal data is lost, can restore the lost data based on other internal data.

In FIG. 1, the storage drive 121A fails and data stored in the storage drive 121A is lost. The controller 110 restores the lost data based on data collected from other storage drives 121B to 121D in the RAID group, and stores the restored lost data in the spare drive 121S (collection copying). The lost data may be dispersed and stored in a plurality of spare drives.

The lost data is restored by performing an exclusive OR operation of the collected data. Therefore, there is no need to read 0 data for restoring the lost data. The controller 110 reads data only from the storage drives storing valid data (host data or parity data) necessary for restoration in restoring the lost data, and restores the lost data. The valid data is data other than 0 data.

For example, in restoring the lost data that was stored in the stripe block 131 of the storage drive 121A, the controller 110 reads data only from the stripe blocks storing valid data, among other stripe blocks 131 that constitute the corresponding stripe line 130.

The controller 110 issues a data storage information request to a storage drive so as to confirm whether the valid data is stored in a designated logical address. The storage drive that has received the data storage information request returns a response indicating whether the valid data is stored in the designated logical address. An example of the data storage information request is a GET LBA STATUS command in an SCSI command.

The storage drive can, for example, notify an area where a physical area of the storage drive is mapped to a designated logical address area in response to the data storage information request. If the physical area is mapped, the logical address area stores the valid data; if not mapped, the logical address area stores 0 data.

By omitting reading of data from the area where 0 data is stored, the drive load and network band consumption in the storage device can be reduced along with data access. As a result, restoration and rebuilding of the lost data is accelerated and the processing load is reduced.

### Embodiment 1

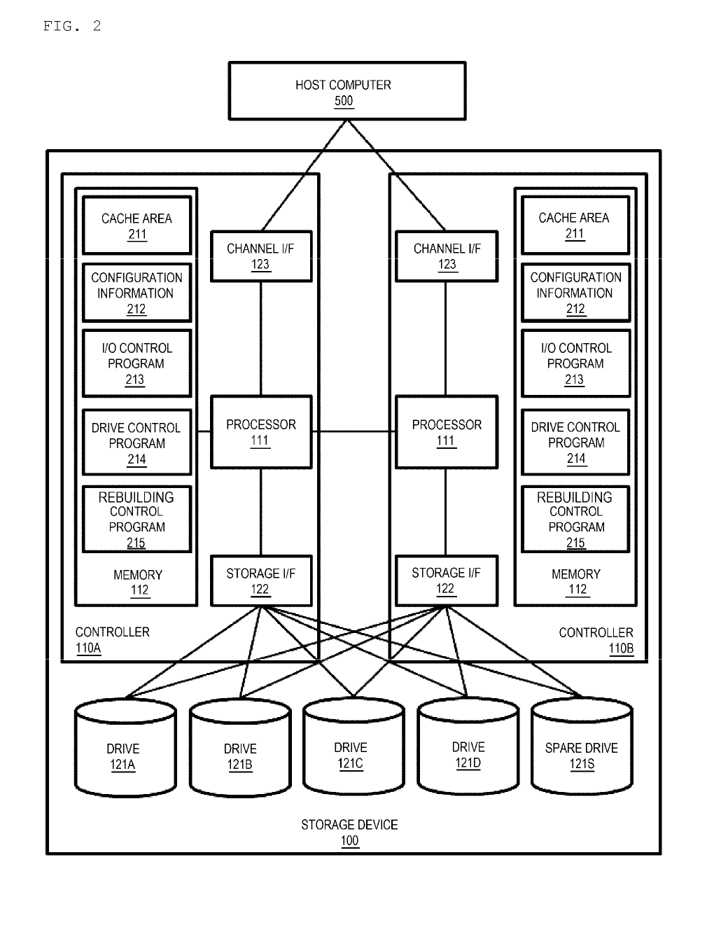

FIG. 2 illustrates a configuration of a computer system according to Embodiment 1. The computer system includes a storage device 100 and one or more host computers 500. The host computer 500 is connected to the storage device 100, for example, via a Storage Area Network (SAN).

The storage device 100 includes a plurality of controllers 110A and 110B, and a plurality of storage drives 121A to 121D, and 121S. The number of the controller may be one. The storage drives 121A to 121D, and 121S are, for example, flash memory storage drives including a flash memory. The storage drives 121A to 121D, and 121S may be other types of storage drives.

The controller 100, for example, controls the plurality of storage drives as an RAID group. The controller 110 represents either one of the controllers 110A and 110B. The controller 110 includes a processor 111, a memory 112, a channel interface (IF) 123, and a storage IF 122.

Each unit in the controller 110 is connected via a bus. The memory 112 includes an area that stores a program and information for controlling the storage device 100, and a cache area 211 that stores data temporarily. In FIG. 2, configuration information 212, an I/O control program 213, a drive control program 214 and a rebuilding control program 215 are stored in the memory 112.

The configuration information 212 includes information about a logical configuration and physical configuration of the storage device 100, and includes information about, for example, a volume provided to the host computer 500, an physical page (page will be described below) allocated to a virtual page of the volume, the cache area, the storage drives and the RAID group.

The I/O control program 213 processes an I/O request from the host computer 500. The drive control program 214 controls the storage drives. The rebuilding control program 215 performs a rebuilding process when a failure of the storage drives occurs.

The processor 111 controls the storage device 100 using the program stored in the memory 112. The processor 111 operates as a predetermined function unit according to the program.

Accordingly, in descriptions where the program is taken as a subject, the subject can be replaced with the processor 111, or the controller 110 including the processor 111, or the storage device 100.

The channel IF 123 is an interface that performs communication with the host computer 500. The storage IF 122 is an interface that performs communication with the storage drives 121A to 121D, and 121S. A manager performs management and maintenance of the storage device 100 from a management terminal (not shown). The manager may perform management and maintenance of the storage device 100 and the like, for example, from the host computer 500.

In the computer system of FIG. 2, the host computer 500 and the storage drives 121A to 121D, and 121S are connected to one another via the controllers 110A and 110B. Alternatively, for example, the host computer 500 and the storage drives 121A to 121D, and 121S may be connected directly, without the controllers 110A and 110B.

The technique of the present disclosure can be applied to a system in which a stripe line is constituted by a plurality of drives, and can be applied to a system in which a storage drive and a storage controller are connected via a network. Further, when two stripe lines are extracted, a form that a portion of stripe blocks belong to different drives may be obtained, as in JP-A-2010-102695.

The technique of the present disclosure can be applied to a storage device and a hyper converged system, for example. The hyper converged system is a system in which a plurality of servers (nodes) including a local storage drive therein are connected to constitute a cluster. A hypervisor having a virtualization function operates in the servers, and the hypervisor is defined by software and causes a server virtual machine and a storage virtual machine to operate.

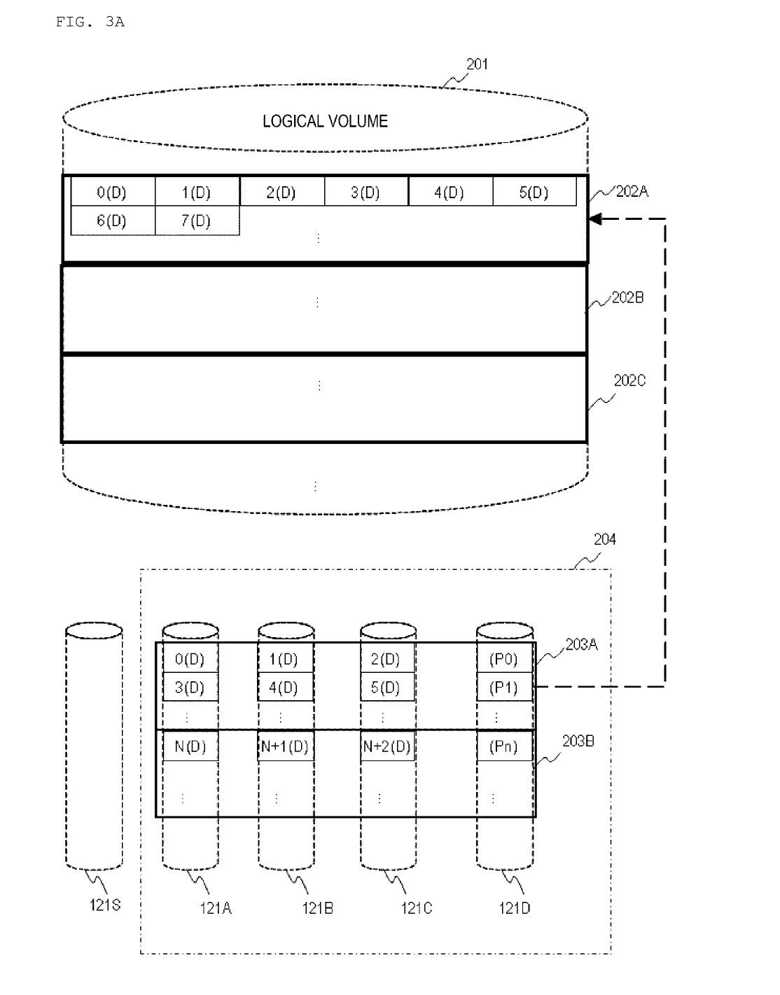

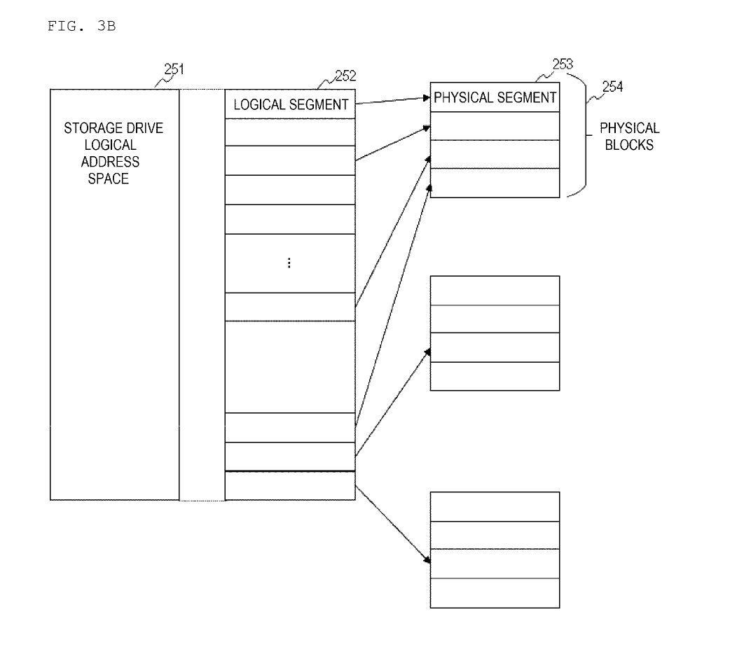

A relation among a logical volume (virtual volume), a virtual page, a physical page and an RAID group will be described with reference to FIG. 3A. The storage controller 110 defines one or more logical volumes and provides the one or more logical volumes to the host computer 500. Information about the above relation (mapping) is included in the configuration information 212.

The space of the logical volume is divided in unit of a virtual page having a predetermined size (for example, 42 MB). The logical address space (logical storage area) of an RAID group 204 is divided in unit of a physical page having a predetermined size. The physical page is dynamically allocated to the virtual page.

The storage controller 110 divides the space of each logical volume into a plurality of virtual pages for management. FIG. 3A illustrates virtual pages 202A, 202B and 202C. The capacity of the virtual pages is common in the present embodiment. Alternatively, virtual pages having different sizes may exist in the storage device 100.

The virtual pages are used for space management of the logical volume 201 in the storage controller 110. When accessing a storage area of the logical volume 201, the host computer 500 designates an access target storage area using a logical address (for example, a Logical Block Address (LBA)). The controller 110 converts the LBA designated by the host computer 500 into a virtual page number and a relative address in the virtual page.

Immediately after the controller 110 has defined the logical volume, the physical page is not allocated to each virtual page. The controller 110 allocates the physical page to the virtual page at the time when receiving a write request from the host computer 500 for the virtual page. In FIG. 3A, a physical page 203A is allocated to a virtual page #0 (202A). The physical page is formed by using logical storage areas of a plurality of storage drives of the RAID group 204. In FIG. 3A, the RAID group 204 has an RAID 4, that is, a 3D+1P configuration.

In FIG. 3A, the storage drives 121A to 121D constitute the RAID group. When one in the RAID group 204 fails, the spare drive 121S stores the data that was stored in the failed drive, and the spare drive 121S is a storage drive for ensuring redundancy of the data stored in the RAID group 204.

The storage controller 110 divides the logical address space of the storage drives constituting the RAID into a plurality of storage areas having a fixed size. The storage areas having a fixed size are stripe blocks. For example, in FIG. 3A, areas represented by 0(D), 1(D), 2(D) . . . , or P0, P1 . . . , are stripe blocks respectively.

In FIG. 3A, among the stripe blocks, the stripe blocks represented by P0, P1 . . . , are parity stripe blocks in which redundant data (parity) generated by an RAID function is stored. The stripe blocks represented by 0(D), 1(D), 2(D) . . . , are data stripe blocks in which data (host data) written from the host computer 500 is stored.

The parity stripe blocks store the redundant data generated by using a plurality of data stripe blocks. A parity stripe block of RAID 1 stores the same data as that in one corresponding data stripe block.

A stripe line is a set of a parity stripe block and a data stripe block that is used for generating the redundant data stored in the parity stripe block. In an example of FIG. 3A, the data stripe blocks 0(D), 1(D), 2(D) and the parity stripe block P0 belong to the same stripe line.

In the example of FIG. 3A, the physical page (for example, 203A and 203B) includes one or a plurality of stripe lines. When the physical page is allocated to the virtual page, the data stripe block is allocated while the parity stripe block is not allocated.

An area where the parity is removed from a top strip line of the physical page is allocated to a top area of the virtual page. Thereafter, in the same manner, the areas where the parity is removed from second and subsequent stripe lines of the physical page are sequentially allocated to the areas of the virtual page.

The storage device 100 obtains the virtual page number and the relative address in the virtual page, based on an access location (LBA) on the logical volume designated by an access request from the host computer 500. Based on a mapping rule between the area in the virtual page and the area in the physical area, the storage drive associated with an access location in the virtual page and the logical address area (data stripe block) of the storage drive can be calculated.

The mapping between each area of the virtual page and each area of the physical page varies depending on a system design. In general, in a capacity virtualization technique, the logical volume is defined so that a total storage capacity of the logical volume is larger than the capacity of a physical storage medium. Thus, the number of the virtual pages is larger than the number of the physical pages.

The physical pages allocated to each virtual page in the logical volume are not limited to the physical pages in the same RAID group. The physical pages allocated to different virtual pages in the logical volume may be physical pages in different RAID groups. The mapping between the virtual pages and the physical pages may be via a capacity pool including storage areas provided by one or a plurality of RAID groups.

Next, the address space of the storage drive will be described. Hereinafter, a storage drive 121 represents any storage drive. The storage drive 121 provides the logical address space (logical volume) of the storage drive to the controller 110 that is a host device. A physical storage area in the storage drive 121 is associated with the logical address space.

The logical address space is divided into logical segments having a predetermined size at the storage drive 121 for management. The storage drive 121 specifies a physical segment from the logical address and performs data read/write, upon receiving a read/write request (I/O request) designating the logical address (logical address area) from the controller 110.

For example, a physical storage area of a flash memory includes a plurality of blocks, and each block includes a plurality of physical segments. The block is a unit for erasing data, and the physical segment is a unit for writing and reading data. The storage drive 121 erases data in unit of a block, and controls writing and reading of data in unit of a physical segment.

FIG. 3B illustrates exemplary configurations of logical segments and physical segments of the storage drive 121. The storage drive 121 provides a logical address space 251 to the controller 110, and divides the logical address space 251 into logical segments 252 having a predetermined size (for example, 8 KB) for management.

The storage drive 121 divides a physical block 254 into physical segments 253 having a predetermined size (for example, 8 KB) for management. The storage drive 121 has a capacity virtualization function. The storage drive 121 dynamically allocates the physical segments 253 to the logical segments 252.

The physical block 254 includes a predetermined number (for example, 256) of physical segments 253. The storage drive 121 performs reading and writing of data in unit of a physical segment and performs erasing in unit of a block.

The storage drive 121 manages the mapping between the logical segments and the physical segments in mapping information (logical-to-physical conversion information). The storage drive 121 allocates a free physical segment to a logical segment and stores new write data in the free physical segment, when writing to the free logical segment or responding to a request of allocation of an area. The storage drive 121 registers anew allocation relation in the mapping information.

The mapping information of the storage drive 121 has, for example, an entry of each logical segment. The entry of the logical segment shows the logical address of the logical segment, and the physical address of the physical segment that is allocated to the logical segment. When the physical segment is not allocated to the logical segment, the entry shows that the physical segment is unallocated.

Upon receiving update data of the physical segment, the storage drive 121 writes the update data to the free physical segment in which no data is stored. The storage drive 121 changes an allocation relation between the physical segment before the update and the logical segment to an allocation relation between the physical segment after the update and the logical segment in a mapping table. Therefore, an access destination logical address (logical segment) of the controller 110 does not change.

The storage drive 121 manages the data before the update as invalid data and the data after the update as valid data. When the invalid data is erased, the segment in which the invalid data was stored becomes a free segment and data can be written thereto. The erasing is performed in unit of a block. When the valid data and the invalid date coexist in the block, the valid data is copied to another free physical segment and the data in the block is erased (garbage collection).

Upon receiving an inquiry designating a logical address (logical address area) from the controller 110, the storage drive 121 returns the inquired information about the designated logical address. For example, as described below, upon receiving a data storage information request, the storage drive 121 refers to the mapping information and returns a response indicating a storage location (area to which the physical area is allocated) of the valid data in the designated logical address (logical area).

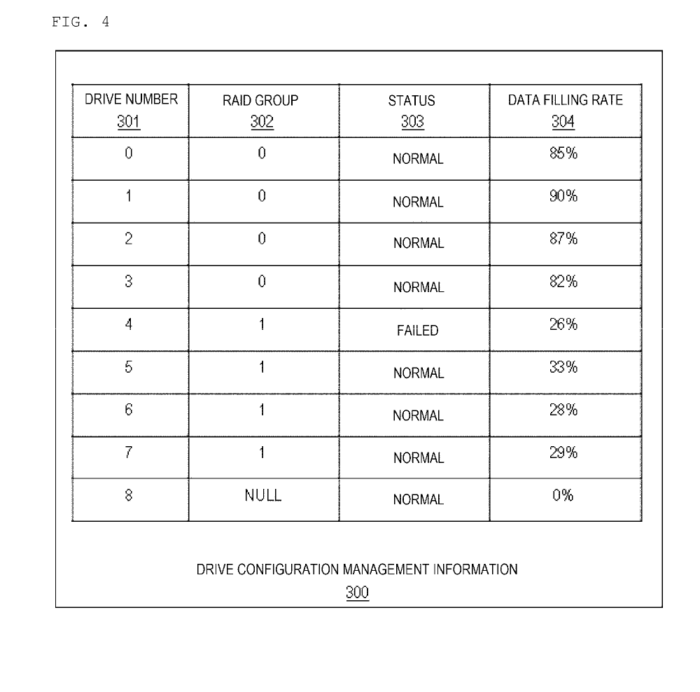

FIG. 4 illustrates an exemplary configuration of drive configuration management information 300 included in the configuration information 212. The drive configuration management information 300 manages information about a status of each storage drive and information about a parity group to which each storage drive belongs. FIG. 3 illustrates an exemplary configuration of RAID 5, and alternatively the RAID group may have other types of the RAID. When different types of RAID groups are included, the storage device 100 stores information indicating a configuration of each parity group.

The drive configuration management information 300 has a drive number column 301, an RAID group column 302, a status column 303 and a data filling rate column 304. The drive number column 301 indicates the number for identifying each storage drive. The RAID group column 302 indicates identifiers of RAID groups to which each storage drive belong. A value of a spare drive in the RAID group column 302 is “NULL”.

The status column 303 indicates the status of each storage drive and indicates weather each storage drive operates normally. When a drive failure is detected, the controller 110 changes the status of the drive to “FAILED” in the status column 303 and selects a normal spare drive. The controller 110 restores the data stored in the failed drive and stores the data in the selected spare drive.

When all data is stored in the spare drive and the rebuilding is finished, the controller 110 changes the value of the spare drive to a number of a rebuilt RAID group in the RAID group column 302. Further, the controller 110 changes the value of the failed drive to “NULL” in the RAID group column 302.

The data filling rate column 304 indicates the proportion of an area where the valid data (data other than 0 data) is stored among the logical areas, used by the host device, in the logical address space provided by each storage drive. For example, a logical area used by the controller 110 is a physical page that is allocated to a virtual page. The filling rate indicates a proportion of an area where the host data or the parity data is stored, in a physical page that is allocated.

As described above, the virtual page, the physical page and the mapping therebetween are managed by the controller 110. The controller 110 manages a free physical page, and a physical page that is allocated to the logical volume. The physical page is defined in the logical address space of an RAID group (storage drive group). Information indicating whether valid data is stored in a physical segment is managed by the storage drive 121.

The controller 110 periodically acquires information about an area where the valid data is stored in the physical page that is allocated, from each storage drive 121, and calculates and updates the filling rate of each storage drive 121.

For example, the controller 110 selects a plurality of areas having a predetermined size (for example, 256 KB) in the logical areas included in the physical page that is allocated, and issues a data storage information request designating the selected areas to each storage drive 121. The controller 110 estimates a filling rate of the storage drive 121 based on sampled information of the area. Thereby, the processing load for determining the filling rate is reduced. When the storage drive 121 does not support the data storage information request, the filling rate is assumed to be 100% in this example.

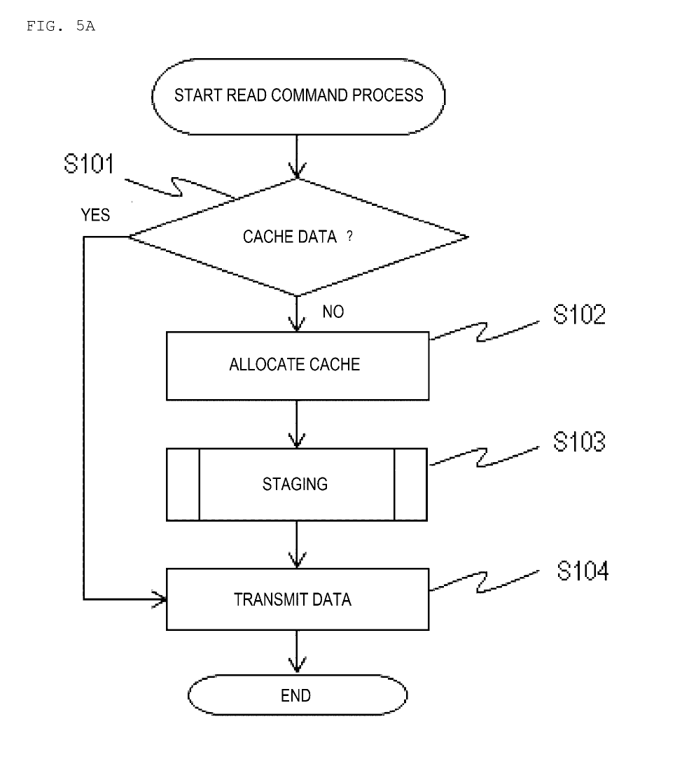

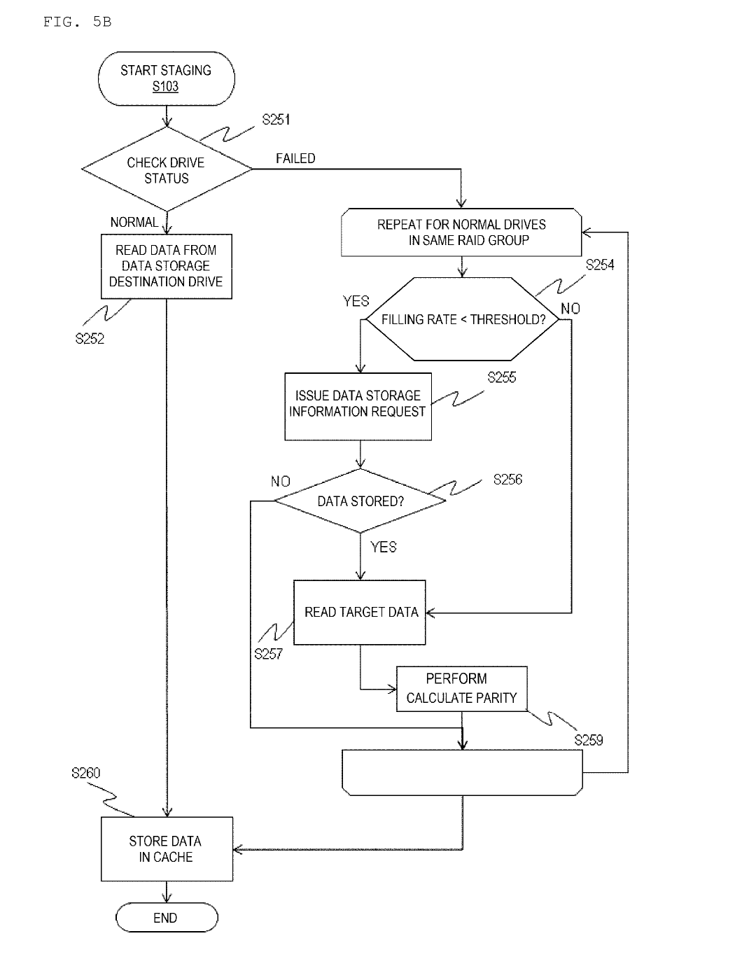

FIG. 5A illustrates a flowchart of a process in response to a read request from the host computer 500. The I/O control program 213 (processor 111) performs the process in response to the read request from the host computer 500.

The I/O control program 213 calculates a virtual page number corresponding to a read target area and a relative address in the virtual page, based on an address of the read target area designated by the received read request.

The I/O control program 213 checks in the configuration information 212 whether read target data is stored in the cache area 211 (S101). When the read target data is stored in the cache area 211 (S101: YES), the I/O control program 213 transmits the data to the host computer 500 (S104).

When the read target data is not stored in the cache area 211 (S101: NO), the I/O control program 213 allocates a slot for storing the read target data in the cache area 211 (S102). The I/O control program 213 loads the read target data from the storage drive 121 into the cache area 211 by using the drive control program 214 (S103). The I/O control program 213 transmits the data to the host computer 500 (S104).

FIG. 5B illustrates a detailed flowchart of the staging S103 in FIG. 5A. The drive control program 214 (processor 111) performs the process when receiving a staging request from another program. When an access destination drive of the read request is normal, the drive control program 214 reads the read target data from the storage drive. When the read target drive fails, the drive control program 214 restores the read target data by data (data in the same stripe line) read from other storage drives in the same RAID group.

The drive control program 214 refers to the configuration information 212, and identifies a physical page number allocated to the read target data and a relative address in the physical page based on the virtual page number of the read target data and the relative address in the virtual page. The drive control program 214 further refers to the configuration information 212, and identifies a storage drive storing the read target data and a logical address of the storage drive based on the physical page number and the relative address in the physical page.

The drive control program 214 checks the status of the read target data by referring to the drive configuration management information 300 or by communicating with the read target drive (S251). When the storage drive 121 is normal (S251: NORMAL), the drive control program 214 issues a read request to the storage drive 121 after designating the logical address, and read the read target data (S252). The drive control program 214 stores the read target data in the cache area 211.

When the storage drive 121 fails (S251: FAILED), the drive control program 214 performs steps S254 to S259 on each normal storage drive that includes all stripe blocks necessary for reading data to restore the lost data in the stripe line in which target stripe blocks are included.

The drive control program 214 refers to the drive configuration management information 300 and specifies an access destination storage drive (stripe line). The storage drive from which the data for data restoration is read depends on the type of the RAID.

The drive control program 214 refers to the drive configuration management information 300 and compares a filling rate of a target storage drive with a threshold (S254). The threshold may be common to the storage drives or may be set for each storage drive. The threshold may be constant or may be determined according to a data length of an access destination.

When the filling rate is smaller than the threshold (S254: YES), the drive control program 214 issues a data storage information request to the target storage drive after designating a logical address area of the target data (S255). When a response to the data storage information request indicates that data is not stored in the designated address area (S256: NO), the drive control program 214 ends the process for the target storage drive.

When a response to the data storage information request indicates that the data is stored in the designated address area (S256: YES), the drive control program 214 reads the target data from a target storage drive 121 (S257) and performs parity calculation (S258). In the parity calculation, an exclusive OR operation is performed with data that is read. The lost data is restored by parity calculation of all the required data.

When the filling rate is equal to or greater than the threshold (S254: NO) in step S254, the drive control program 214 reads the target data from the target storage drive 121 without issuing the data storage information request (S257). It is assumed that the filling rate of the storage drive that does not support the data storage information request is 100%, and the data storage information request is not issued. The filling rate of the storage drive that does not support the data storage information request may be equal to or greater than the threshold.

As described above, by inquiring whether the valid data necessary for restoring the lost data is stored in other storage drives in the RAID group, reading of 0 data and parity calculation are omitted, and the restoration process of the lost data can be performed efficiently. When the filling rate of the storage drive is smaller than the threshold, there is a high probability that the valid data is not stored in the target address area. By issuing the data storage information request when the filling rate is smaller than the threshold, issuing of an unnecessary data storage information request can be reduced.

A rebuilding process to be described below is started when the failure of the storage drive is discovered for the first time by the process in response to the above-described read request. Further, the process in response to the above-described read request can also be performed during the rebuilding. When the access destination of the read request is restored, the access destination drive may be a failed drive or a copying destination spare drive.

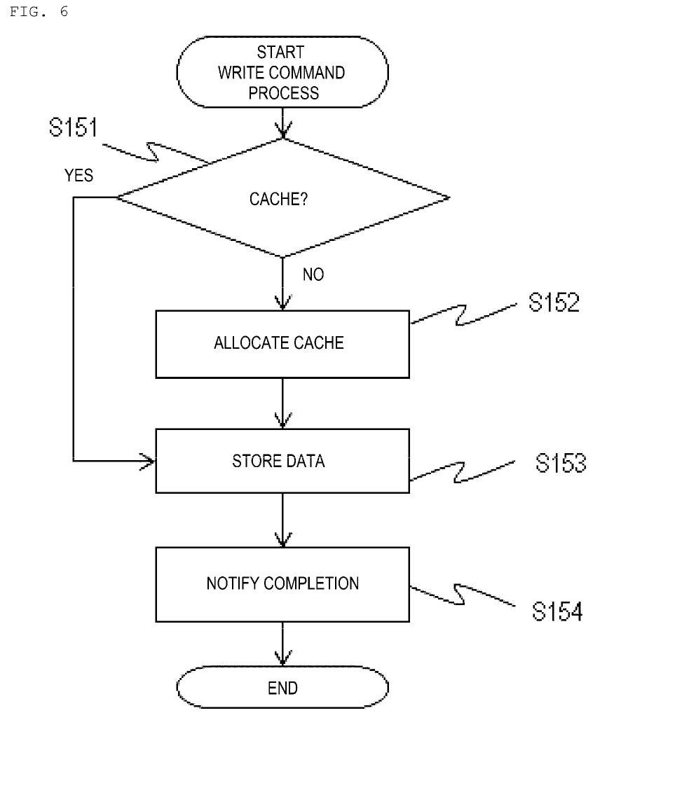

FIG. 6 illustrates a flowchart of a process in response to a write request from the host computer 500. The I/O control program 213 (processor 111) performs the process when receiving the write request from the host computer 500.

The I/O control program 213 calculates a virtual page number corresponding to a write target area and a relative address in the virtual page, based on an address of the write target area designated by the received write request. The I/O control program 213 checks in the configuration information 212 whether data of the write target area is stored in the cache area 211 (S151).

When the data of the write target area is not stored in the cache area 211 (S151: NO), the I/O control program 213 allocates a slot for storing the write target data in the cache area 211 (S152). The I/O control program 213 stores the write target data in the cache area 211 from a buffer of the channel I/F 123 (S153). Thereafter, the I/O control program 213 transmits a completion notification to the host computer 500 (S154).

When the data of the write target area is stored in the cache area 211 (S151: YES), the I/O control program 213 overwrites the old data in the cache area 211 by using the received update data (S153).

The I/O control program 213 stores the write data stored in the cache area 211 in the storage drive 121 after transmitting the completion notification of the write process to the host computer 500 (destaging).

The I/O control program 213 refers to the configuration information 212 and checks whether a physical page is allocated to a designated virtual page. When the physical page is not allocated, the I/O control program 213 allocates a free physical page to a virtual page that includes the write target area.

The I/O control program 213 generates parity data corresponding to the write data, and stores the write date and the parity data in the corresponding storage drive 121 respectively. The parity data is generated by calculating exclusive OR of new write data, old write data and old redundant data.

When a storage destination drive of the write data fails, the I/O control program 213 stores the write data in a spare drive, for example. Further, the I/O control program 213 generates new parity data based on the write data and other data of the corresponding stripe line. In generating the parity data, reading of 0 data based on a data storage information request is omitted as in restoring the lost data which is described with reference to FIG. 5B.

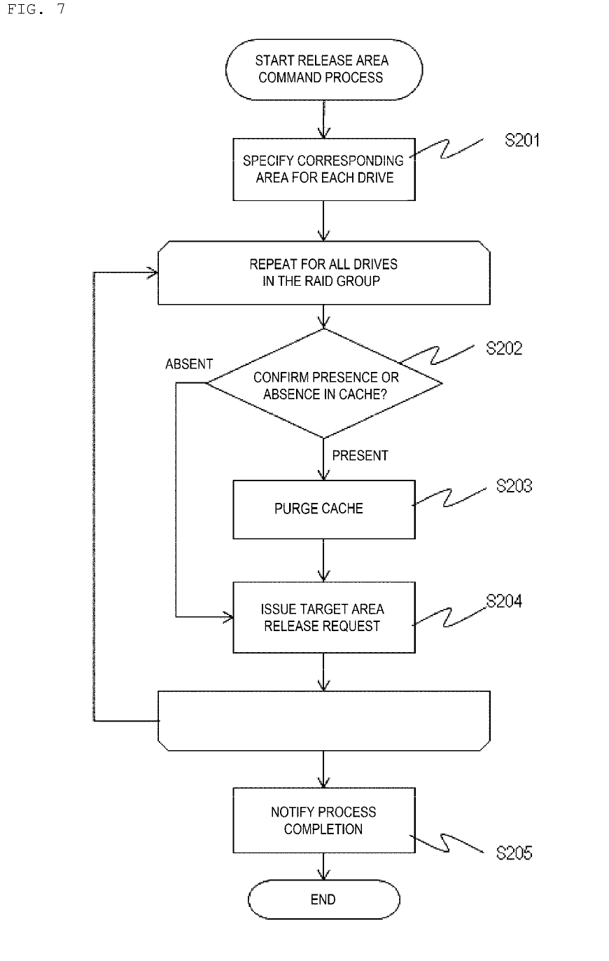

FIG. 7 illustrates a flowchart of a process in response to an area release request from the host computer 500. The I/O control program 213 (processor 111) performs the process when receiving the area release request from the host computer 500. An example of the area release request is, for example, an UNMAP command of an SCSI or a TRIM command of an SATA.

The I/O control program 213 (processor 111) receives an area release request designating an area from the host computer 500. A size that can be designated by the area release request is determined between the storage device 100 and the host computer 500 in advance, and a virtual page or a stripe line (not including parity data) in the virtual page is designated.

The I/O control program 213 specifies a virtual page number and a corresponding physical page number based on an address designated by the area release request. When a virtual page is designated, the I/O control program 213 changes information about a physical page allocated to the designated virtual page, to be unallocated in the configuration information 212. When a stripe line is designated, a relative address in the virtual page and a relative address in the physical page are also specified.

The I/O control program 213 specifies a storage drive for each target stripe line and a logical address for the storage drive based on information about a physical page (S201). The I/O control program 213 performs steps S202 to S204 for each stripe line (including parity data). First, the I/O control program 213 determines whether data of a logical segment is stored in the cache area 211 by referring to the configuration information 212 (S202).

When the target data is stored in the cache area (S202: YES), the I/O control program 213 discards the data from the cache area 211 (S203). When the target data is not stored in the cache area (S202: NO), step S203 is skipped.

The I/O control program. 213 designates a logical address area and issues a target area release request to a target storage drive 121 (S204). An example of the release request is an UNMAP command of an SCSI or a TRIM command of an SATA. The storage drive 121 releases a physical segment that is allocated to the designated logical address area. The I/O control program 213 returns a completion notification to the host computer 500 when steps S202 to S204 are performed for all stripe lines (S205). By the process, unallocated physical segments are increased in the storage drive, so that the rebuilding can be performed more efficiently.

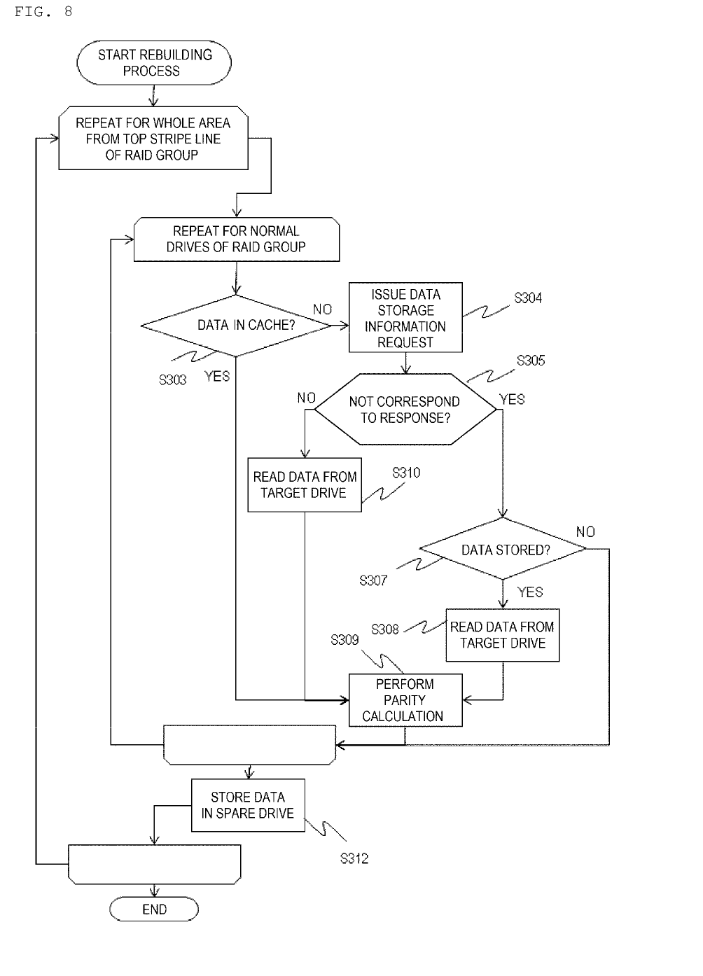

FIG. 8 illustrates a flowchart of a rebuilding process in response to a failure of the storage drive 121. The rebuilding control program 215 (processor 111) performs the process when the failure of the storage drives is detected. For example, the status of the storage drives is checked in synchronization with host I/O, and is checked periodically.

The rebuilding control program 215 performs steps S303 to S312 for each stripe line (symmetrical stripe line) including a stripe block of the failed drive. The rebuilding control program 215 refers to the drive configuration management information 300, specifies each normal access destination storage drive (each access destination stripe block) necessary for reading data to restore the lost data of the stripe block, and performs steps S303 to S310 for each access destination storage drive.

In step S303, the rebuilding control program 215 determines whether data of the stripe block is stored in the cache area 211 by referring to the configuration information 212. When the target data is stored in the cache area 211 (S303: YES), the rebuilding control program 215 reads the data from the cache area 211 and performs parity calculation (S309). The parity calculation S309 is the same as the parity calculation S259 as illustrated in FIG. 5B.

When the target data is not stored in the cache area 211 (S303: NO), the rebuilding control program 215 issues a data storage information request to a target storage drive after designating a logical address area of the target stripe block (S304). When a response to the data storage information request indicates that the storage drive 121 does not support the request (S305: NO), the rebuilding control program 215 reads the data of the target stripe block from the target storage drive 121 (S310).

When a response to the data storage information request indicates that valid data is not stored in the designated address area (S305: YES, S307: NO), the rebuilding control program. 215 ends the process for the target storage drive.

When a response to the data storage information request indicates that the valid data is stored in the designated address area (S305: YES, S307: YES), the rebuilding control program 215 reads the data of the target stripe block from the target storage drive 121 (S308) and performs the parity calculation (S309). When the lost data of the stripe block is restored, the rebuilding control program 215 stores the restored data in a spare drive (S312).

When an area, where the valid data is stored, in the designated address area is dispersed (when the target area is fragmented), the response to the data storage information request may only indicate that the data is stored in the designated address area, or may indicate each area where the valid data is stored.

When the response indicates each area where the valid is stored, the rebuilding control program 215 may issue a read request (gathered read request) designating all areas where the valid data is stored. Accordingly, the valid data in a plurality of areas can be read by one time of communication.

When the restored data of the stripe block is constituted by sub-blocks of dispersed valid data (when the restored data is fragmented), the rebuilding control program 215 may issue a write request (scattered write request) designating all address areas of the valid data. Accordingly, the data in a plurality of areas can be written by one time of communication.

By issuing the data storage information request, the rebuilding control program 215 avoids reading 0 data, which is unnecessary for restoring the lost data, and the parity calculation, and can perform the rebuilding process efficiently. Since the data is read from the storage drive that does not support the data storage information request according to the response, the above-described rebuilding process can be applied to the storage device 100 in which the storage drive supporting the data storage information request and the storage drive not supporting the data storage information request coexist.

The rebuilding control program 215 does not determine whether the data storage information request based on the filling rate is issued, unlike the process in response to the host read request. Accordingly, the process is performed efficiently. Since the size of the data read in the rebuilding is large (sequential read), the load of unnecessary reading is large when the valid data does not exist, and the processing time of issuing the data storage information request is short for data reading.

The rebuilding control program 215 may determine whether the data storage information request based on the filling rate is issued. The lost data of the failed drive is restored based on the data dispersed in a plurality of drives and the parity data. The restored lost data may be stored in a spare area of a storage drive storing the host data.

### Embodiment 2

In the present embodiment, reading data from a physical storage area corresponding to a virtual page to which no physical page is allocated is avoided. Accordingly, the rebuilding process can be performed more efficiently.

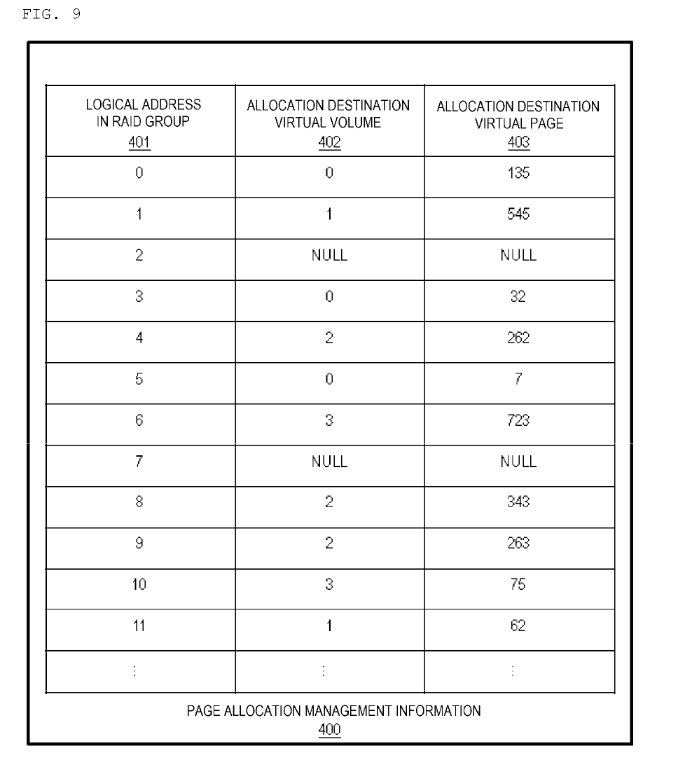

FIG. 9 illustrates an exemplary configuration of page allocation management information 400. The page allocation management information 400 is included in the configuration information 212. The page allocation management information 400 manages physical pages. In an example of FIG. 9, it is assumed that one physical page includes a logical address area of one RAID group. The page allocation management information 400 is prepared for each RAID group.

The page allocation management information 400 has a logical address in RAID group column 401, an allocation destination virtual volume column 402, and an allocation destination virtual page column 403. The logical address in RAID group column 401 indicates addresses of physical pages in logical address areas provided by an RAID group. The allocation destination virtual volume column 402 indicates the virtual volume number to which the physical pages are allocated. The allocation destination virtual page column 403 indicates the virtual page number to which the physical pages are allocated. In the allocation destination virtual volume column 402 and the allocation destination virtual page column 403, an entry of a physical page that is not allocated indicates “NULL”.

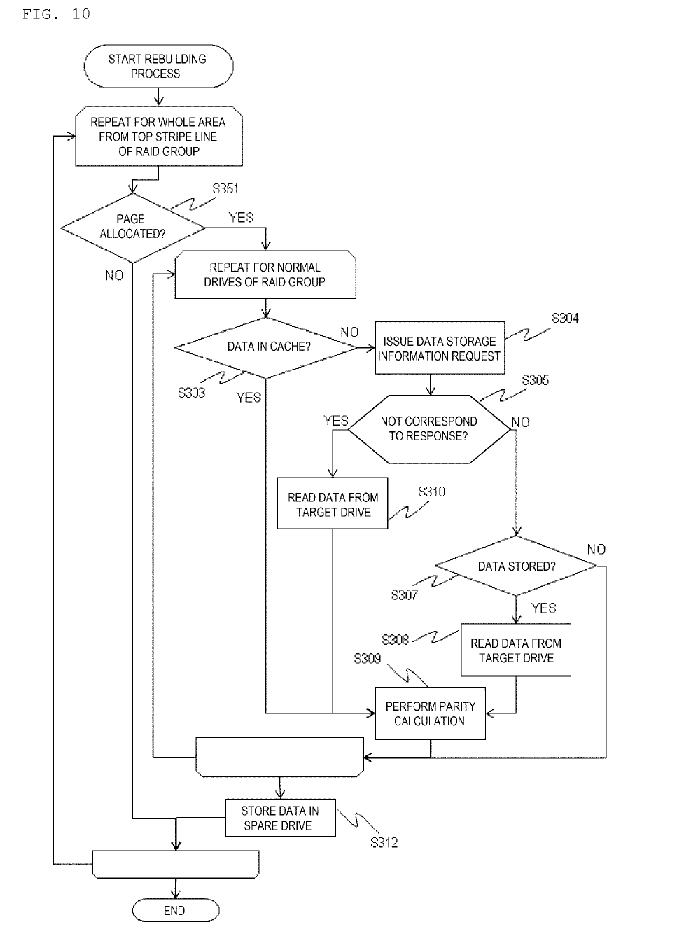

FIG. 10 illustrates a flowchart of a rebuilding process according to the present embodiment. Differences from the rebuilding process of Embodiment 1 described with reference to FIG. 8 will be described. In FIG. 10, the rebuilding control program 215 determines whether a physical page, in which a target stripe line is included, is allocated to a virtual page (S351). When the physical page is not allocated (S351: NO), the rebuilding control program 215 ends the process for the target stripe line. When the physical page is allocated (S351: YES), the rebuilding control program 215 proceeds to step S303.

### Embodiment 3

The present embodiment discloses a method for efficiently performing data copying between volumes. In the above-described embodiments, reading of 0 data is avoided when a drive failure occurs. In the present embodiment, reading of 0 data is avoided in data copying between the volumes.

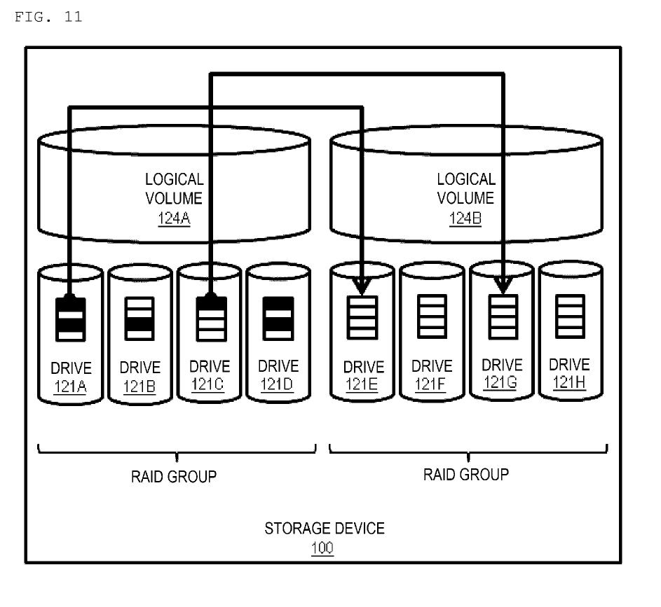

FIG. 11 illustrates a volume configuration according to the present embodiment. The storage device 100 includes logical volumes 124A and 124B that constitute a local copy pair. For example, the logical volume 124A is provided to the host computer 500, and the logical volume 124B is a backup volume.

When forming the copy pair, data in the logical volume 124A is copied to the logical volume 124B so that data in both volumes are identical (forming copying). The storage device performs the copying process efficiently by only copying valid data (excluding parity data) in the forming copying.

In FIG. 11, a storage area of an RAID group constituted by the storage drives 121A to 121D is allocated to the logical volume 124A, and a storage area of another RAID group constituted by storage drives 121E to 121H is allocated to the logical volume 124B. The capacity of the logical volumes 124A and 124B may be virtualized or may not be virtualized.

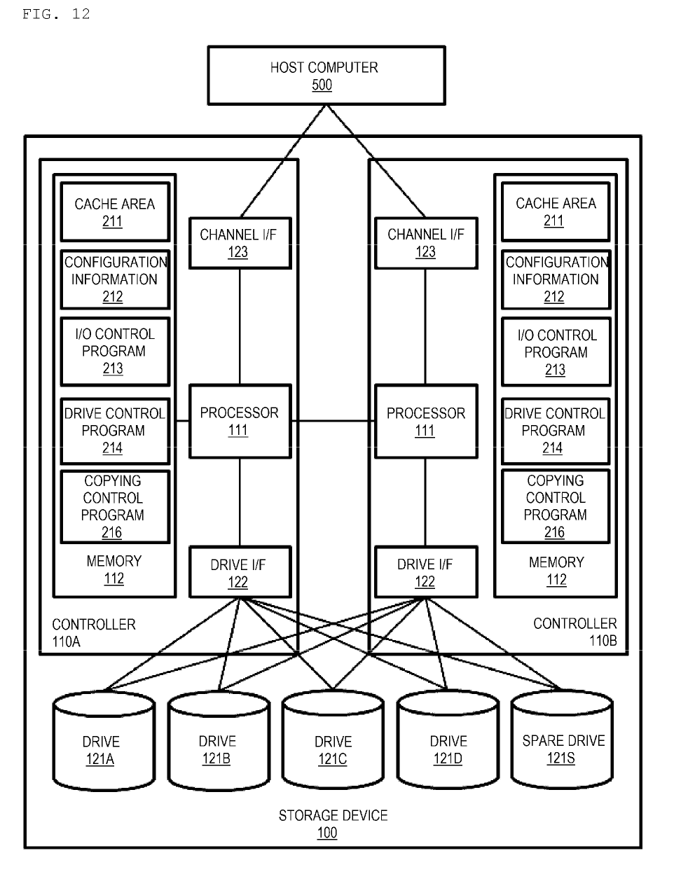

FIG. 12 illustrates a configuration of a computer system according to Embodiment 3. The difference from the configuration of Embodiment 1 is that the storage device 100 includes a copying control program 216 instead of the rebuilding control program 215.

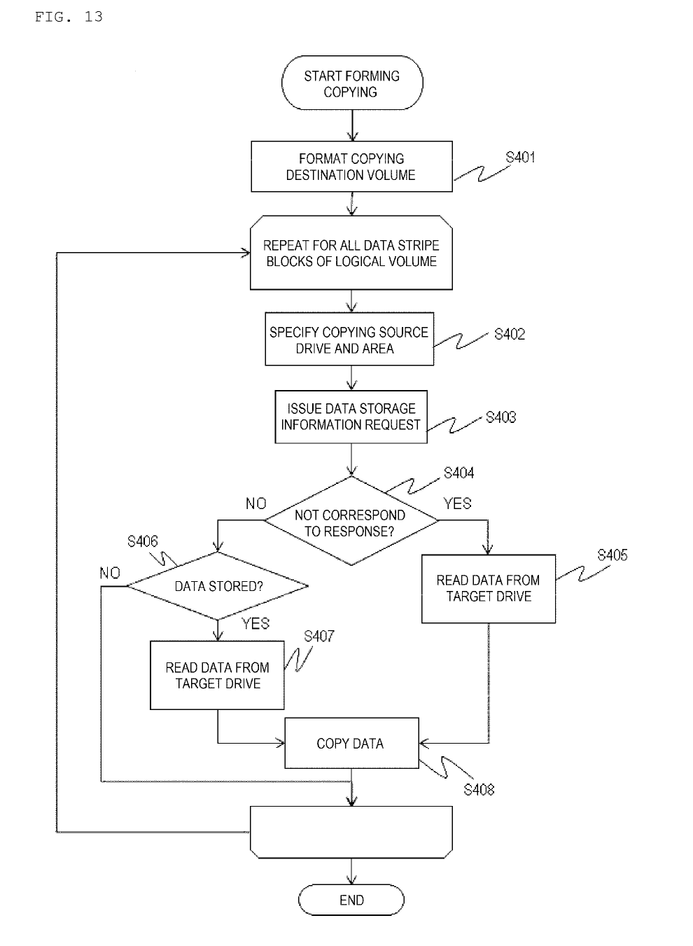

FIG. 13 illustrates a flowchart of a forming copying process performed by the copying control program 216. First, the copying control program 216 formats the copying destination logical volume 124B (S401). The copying control program 216 performs steps S402 to S408 for each data stripe block of the copying source logical volume 124A.

The copying control program. 216 specifies a storage drive and a logical address area of a target data stripe block by referring to the configuration information 212 (S402). The copying control program 216 issues a data storage information request to a target storage drive 121 after designating the logical address area of the target data stripe block (S403).

When a response to the data storage information request indicates that the target storage drive 121 does not support the request (S404: YES), the copying control program 216 reads data of the target data stripe block from the target storage drive 121 (S405) and copies the data to the copying destination logical volume 124B (S408).

When a response to the data storage information request indicates that the data is not stored in the designated address area (S406: NO), the copying control program 216 ends the process for the target storage drive 121.

When a response to the data storage information request indicates that the data is stored in the designated address area (S406: YES), the copying control program 216 reads the data of the target data stripe block from the target storage drive 121 (S407) and copies the data to the copying destination logical volume 124B (S408).

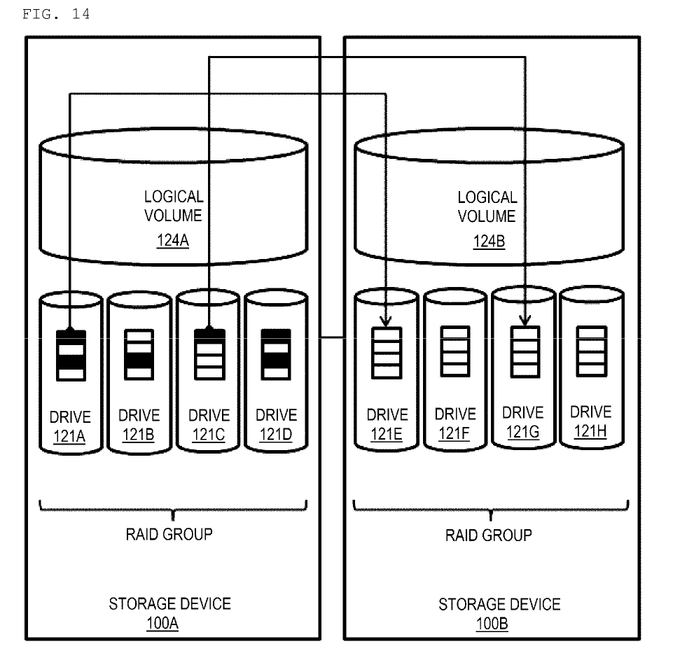

The above-described forming copying process can be applied to a remote copy pair constituted by logical volumes of different storage devices. FIG. 14 illustrates an exemplary configuration of the remote copy pair. A storage device 100A includes a logical volume 124A and a storage device 100B includes a logical volume 124B. In the forming copying the valid data (excluding parity data) of the logical volume 124A is transmitted from the storage device 100A to the storage device 100B via a network.

Copying control programs 216 of the storage devices 100A, 100B perform communication and perform forming copying according to the flowchart of FIG. 13. The copying control program 216 of the storage device 100B formats the logical volume 124B. Only the valid data is read from the logical volume 124A and transferred to the storage device 100B. The copying control program 216 of the storage device 100B stores the received data in the logical volume 124B.

It should be noted that the invention is not limited to the above-described embodiments and includes various modifications. For example, the above-described embodiments have been described in detail in order to facilitate the understanding of the invention, but the invention is not necessarily limited to have all of the described configurations. A part of the configuration of one embodiment can be replaced with the configuration of another embodiment, and the configuration of another embodiment can also be added to the configuration of one embodiment. In a part of the configuration of each embodiment, another configuration can be added, removed, or replaced.

The above-described configurations, functions, processing units, or the like may be achieved by hardware by means of designing a part or all of them with, for example, an integrated circuit. The above-described configurations, functions, or the like may be achieved by software by means of interpreting and executing a program, by a processor, for achieving the respective functions. Information about programs, tables, files or the like for implementing each function can be placed in a recording device such as a memory, a hard disk, and a solid state drive (SSD), or a recording medium such as an IC card and an SD card.

Further, control lines and information lines shows those considered to be necessary for the description, and not all the control lines and information lines are necessarily shown on the product. In practice, almost all the configurations may be considered to be mutually connected.

1. A device for restoring lost data due to a failure of a storage drive, the device comprising:
a memory; and
a processor that operates according to a program stored in the memory,
wherein the processor
selects a first logical area of a first storage drive that is failed,
specifies a first logical area line that includes the first logical area and logical area blocks of a different storage drive, and stores a data set having a redundant configuration capable of restoring lost internal data,
selects, from the first logical area line, one or more second logical areas to be accessed for restoring data of the first logical area, and
for each of one or more second storage drives that provides the one or more second logical areas respectively,
issues a data storage information request inquiring whether valid data is stored after designating the second logical areas,
issues a read request designating the second logical areas, when a response for the data storage information request is returned which indicates that the valid data is stored, and
omits the read request when the response for the data storage information request is returned which indicates that the valid data is not stored, and
restores the data of the first logical area by using data read from the one or more second storage drives.

2. The device according to claim 1,
wherein the processor
selects target areas having a predetermined size from a logical address area of the first storage drive sequentially,
restores data of the sequentially selected target areas and stores the data in one or more other storage drives,
in restoring data of at least a portion of target areas of the sequentially selected target areas,
specifies a target logical area line that includes the target areas and logical area blocks of a different storage drive, and stores a data set having a redundant configuration capable of restoring lost internal data,
selects, from the target logical area line, one or more access destination logical areas to be accessed for restoring the data of the target areas,
for each of one or more access destination storage drives that provides the one or more access destination logical areas respectively,
issues a data storage information request inquiring whether valid data is stored after designating the access destination logical areas,
issues a read request designating the access destination logical areas, when a response for the data storage information request is returned which indicates that the valid data is stored, and
omits the read request when the response for the data storage information request is returned which indicates that the valid data is not stored, and
restores the data of the target logical areas by using data read from the one or more access destination storage drives.

3. The device according to claim 2,
wherein the processor skips restoration of data of a logical area that is not allocated to a volume, in the logical address area of the first storage drive.

4. The device according to claim 1,
wherein the first logical area is an access destination of a read request received from a host computer, and
the processor returns the restored data of the first logical area to the host computer.

5. The device according to claim 1,
wherein the processor
issues the data storage information when a filling rate of an issuing target storage drive of the data storage information request is smaller than a threshold, and
the filling rate indicates a proportion of an area where valid data is stored in a physical storage area, in an area allocated from a logical address space provided by the issuing target storage drive.

6. The device according to claim 1,
wherein the processor, in response to an area release request received from a host computer for a specified area in a volume, issues an area release request designating a logical area that is allocated to the specified area, to a storage drive having the allocated logical area.

7. The device according to claim 1,
wherein the processor
determines whether an issuing target storage drive of the data storage information request supports the data storage information request, and
issues a read request to the issuing target storage drive when the issuing target storage drive does not support the data storage information request.

8. The device according to claim 1,
wherein the processor,
in data copying from a first volume to a second volume,
selects target areas from the first volume sequentially, and
in reading data of at least a portion of target areas of the sequentially selected target areas,
for a storage drive that provides the target areas,
issues a data storage information request inquiring whether valid data is stored after designating the target areas,
issues a read request designating the target areas, when a response for the data storage information request is returned which indicates that the valid data is stored, and
omits the read request when the response for the data storage information request is returned which indicates that the valid data is not stored.

9. A method for restoring lost data due to a failure of a storage drive, the method comprising:
selecting a first logical area of a first storage drive that is failed;
specifying a first logical area line that includes the first logical area and logical area blocks of a different storage drive and stores a data set having a redundant configuration capable of restoring lost internal data;
selecting, from the first logical area line, one or more second logical areas to be accessed for restoring data of the first logical area;
for each of one or more second storage drives that provides the one or more second logical areas respectively,
issuing a data storage information request inquiring whether valid data is stored after designating the second logical areas,
issuing a read request designating the second logical areas, when a response for the data storage information request is returned which indicates that the valid data is stored, and
omitting the read request when the response for the data storage information request is returned which indicates that the valid data is not stored; and
restoring the data of the first logical area by using data read from the one or more second storage drives.
